(19) United States
(12) Patent Application Publication
(10) Pub. No.: US 2015/0222030 A1
(43) Pub. Date: Aug. 6, 2015

(54) Electrical Protection Band

(71) Applicant: John D. Schrader, Willcox, AZ (US)

(72) Inventor: John D. Schrader, Willcox, AZ (US)

(21) Appl. No.: 14/173,547

(22) Filed: Feb. 5, 2014

(51) Int. Cl. H01R 4/70; H02G 3/18

(52) U.S. Cl. CPC H01R 4/70; H02G 3/18

(57) ABSTRACT

The invention provides a new way to complete electrical installations to reduce or eliminate hazards of shorting wires or getting shocked. Electricians stretch the invention over a switch or outlet to cover bare screws and wires. This final step in electrical installations will quickly and easily provide a protective shield making initial installation, future repairs and replacements safer.

The invention will be made of a stretchable material in the dimensions required to fit various outlets and switches.

### CROSS REFERENCE TO RELATED APPLICATION

Not applicable.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of electricity. More particularly, the present invention is in the field of safety devices for electrical installations.

The problem is that when electrical switches and outlets are installed, metal screws and wires may be left uncovered. These uncovered metal parts present a safety hazard if accidentally touched whenever the switch or outlet is accessed. There is currently no quick and easy method to cover exposed metal parts to protect users from shock and wires from shorting. This invention is to solve the problem of unprotected metal parts in switches and outlets creating a potential electrical hazard.

### SUMMARY OF INVENTION

The invention is an easily installed, stretchable band to cover exposed metal parts in electrical switches and outlets.

The invention is to be used in installation of electrical outlets and switches. The invention is a stretchable band made in specific sizes to go over outlets and switches in all building electrical installations. The invention is used once wires have been attached to outlets and switches, during initial installation, or repair. To use the invention, the installer selects the appropriate size, stretches it over the device to cover all screws and exposed wire ends, and then completes the installation. When the switch or outlet cover is removed for any future repairs or rewiring, the hazard of being shocked is eliminated because the user cannot touch any raw metal if there is this invention covering the metal parts.

### DESCRIPTION OF DRAWINGS

FIG. 1 is an Outlet front view

FIG. 2 is an Outlet side view

FIG. 3 is the invention

FIG. 4 is an Outlet with invention installed

FIG. 5 is a Switch front view

FIG. 6 is a Switch side view

FIG. 7 is the invention

FIG. 8 is a Switch with invention installed

A. Common terminal screw

B. Power terminal screw

C. Grounding screw

D. Retaining screw to attach receptacle to box

Drawings show what an outlet and switch look like with bare metal screws exposed before installing invention, and how these screws are protected after installing the invention.

### DESCRIPTION OF INVENTION

This invention is a stretchable band used to cover bare metal parts in electrical installations.

Refer to the Drawings page. The DRAWINGS page shows both an outlet and a switch, before and after installing the invention. Note in both drawings that bare screws and wires are showing.

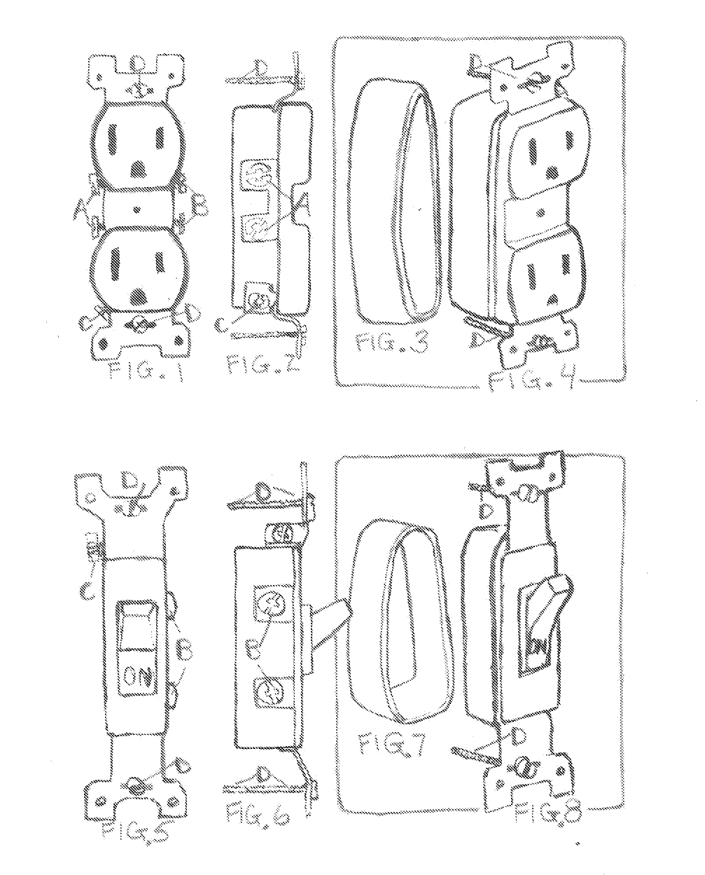

FIG. 1 shows the front of an outlet. FIG. 2 shows the side of an outlet. This invention has not been installed. FIG. 3 shows an example of the invention ready to be installed. FIG. 4 shows the outlet with the invention stretched over the back to cover the bare screws and ends of the wires attached to the screws.

FIG. 5 shows the front of a switch. FIG. 6 shows the side of a switch. This invention has not been installed. FIG. 7 shows an example of the invention ready to be installed. FIG. 8 shows the outlet with the invention stretched over the back to cover the bare screws and ends of the wires attached to the screws.

To use the invention, first attach all wires to hook up the outlet (FIG. 1 and FIG. 2) or switch (FIG. 5 and FIG. 6). Then select 1 band (this invention) as shown in FIG. 3 or FIG. 7, and stretch it around the back of the outlet or switch, making sure to cover all exposed screws. As shown in the drawings, this band will cover all screws labeled A, B, C. FIG. 4 shows an outlet with the invention installed. FIG. 8 shows a switch with the invention installed. Continue with the installation and attach the cover plate when done.

3

The invention consists of one stretchable band. This band expands to the correct size to wrap around a switch or outlet to cover exposed screws and wires. Use of this product will solve the problem of the hazards of shorting wires, or getting shocked, when installing or repairing outlets and switches with raw metal exposed.

No single item exists to meet this need currently. Some electricians recognize the need to cover the screws and wires to reduce the hazard of shock, and may use electrical tape to wrap around the electrical device. Using tape is inexact, difficult, messy, expensive, and requires tools. The invention is easy to use, quick, and inexpensive, and can be done with no additional tools. The invention takes almost no space in the electrical box. There is not currently a stretchable band made in the correct dimensions to be used instead of the invention.

A rubber-band company will manufacture the invention. It will be made of a stretchable material in custom sizes to exactly fit target electrical devices. The invention will have all of the properties of currently mass produced stretchable bands. The invention will come in different colors so that color-coding for different purposes can be accomplished. The invention will provide a surface that can be written on if necessary. The invention will be reusable, made of durable material that can withstand being taken on and off the electrical devices.

Consumers will purchase the invention in different quantities for small jobs, or larger quantities for complete home or building applications. Each switch and outlet in a building will have 1 band. This invention will be used during initial installation of an outlet or switch. It can also be used when an outlet or switch is replaced.

When used correctly, the invention is a stretchable band, installed to cover exposed screws and wires in an electrical installation. It will reduce the hazards of shock and wires shorting.

This invention:

1. Is a stretchable, continuous band used to cover metal parts in electrical installations

2. Is manufactured in various sizes, lengths, widths, and thicknesses

3. Fits standard electrical outlets and switches

4. Can be produced in different colors, with or without text on band
